(19) United States
(12) Patent Application Publication
(10) Pub. No.: US 2013/0185070 A1
(43) Pub. Date: Jul. 18, 2013

(54) NORMALIZATION BASED DISCRIMINATIVE TRAINING FOR CONTINUOUS SPEECH RECOGNITION

(71) Applicants: Qiang Huo, Beijing (CN); Zhi-Jie Yan, Beijing (CN); Yu Zhang, Shanghai (CN)

(72) Inventors: Qiang Huo, Beijing (CN); Zhi-Jie Yan, Beijing (CN); Yu Zhang, Shanghai (CN)

(73) Assignee: Microsoft Corporation, Redmond, WA (US)

(21) Appl. No.: 13/349,529

(22) Filed: Jan. 12, 2012

(51) Int. Cl. G10L 15/06

(52) U.S. Cl. 704/243; 704/E15.007

(57) ABSTRACT

A speech recognition system trains a plurality of feature transforms and a plurality of acoustic models using an irrelevant variability normalization based discriminative training. The speech recognition system employs the trained feature transforms to absorb or ignore variability within an unknown speech that is irrelevant to phonetic classification. The speech recognition system may then recognize the unknown speech using the trained recognition models. The speech recognition system may further perform an unsupervised adaptation to adapt the feature transforms for the unknown speech and thus increase the accuracy of recognizing the unknown speech.

### BACKGROUND

Speech recognition has become ubiquitous in an array of diverse technologies, such as dictation software, computer operating systems, mobile and cellular devices, automotive navigation and entertainment systems, video gaming systems, telephony systems, and numerous other types of applications and devices. Typical speech recognition systems rely on one or more statistical models for recognizing an utterance or segment of speech to obtain a result, such as recognizing one or more words or word portions from a speech segment. Examples of statistical models that are commonly used in speech recognition include Hidden Markov Models (HMMs), segment models, dynamic time warping, neural nets, etc. Further, prior to using a model to recognize a speech segment, the model is typically trained using training data. For example, a large collection of acoustic signals may be obtained from speakers, for example, by reading from a known text, speaking specified sounds, etc. This collection of acoustic speech signals may then be used to train the model to recognize speech sounds identified as being statistically or probabilistically similar to the training data.

Once the model is trained, the model can be used by a speech recognition system for recognizing a segment of speech. Typically, an incoming speech waveform of the speech segment is first reduced to a sequence of feature vectors. The sequence of feature vectors may then be matched with the model to recognize the speech. Therefore, an accuracy of a speech recognition system generally depends on a model that is used for recognizing a speech and training data that is used for training the model. Further, the accuracy may be affected if a speaker does not speak in a manner that closely resembles the training data or is in an environment that does not match the environment in which the training data was recorded. This can cause irrelevant acoustic information to be included in the sequence of feature vectors, which can cause inaccuracy during speech recognition.

### SUMMARY

This summary introduces simplified concepts of speech recognition, which are further described below in the Detailed Description. This summary is not intended to identify essential features of the claimed subject matter, nor is it intended for use in limiting the scope of the claimed subject matter.

This application describes example embodiments of speech recognition. In one embodiment, training data may be received from one or more sources. The training data may include raw speech data or pre-extracted features of the raw speech data obtained from a plurality of speakers under a plurality of different environments and/or conditions. In response to receiving the training data, a set of statistical models and a set of feature transforms may be cooperatively trained from the received training data based on an irrelevant variability normalization (IVN) based discriminative training (DT) approach. In one embodiment, the statistical models are configured to discriminate phonetic classes from one another. Additionally, the feature transforms may be configured to ignore variability that is irrelevant to phonetic classification from each feature vector of the received training data or an unknown speech segment.

In some embodiments, an unknown speech segment may be received. Upon receiving the unknown speech segment, the unknown speech segment is recognized using the set of trained statistical models and the set of trained feature transforms. In one embodiment, an unsupervised adaptation may be performed for the unknown speech segment. For example, for each feature vector of the unknown speech segment, a respective feature transform may be identified from the set of trained feature transforms using acoustic sniffing. Each feature vector of the unknown speech segment may then be transformed using respective identified feature transforms and recognized using the set of trained statistical models. Upon recognizing each transformed feature vector of the unknown speech segment, parameters of the trained feature transforms or respective identified feature transforms may be re-estimated based at least on a recognition result of the unknown speech segment. The feature vectors may then be transformed using re-estimated parameters of the feature transforms and recognized using the trained statistical models, and the parameters of the feature transforms may be re-estimated again until a predetermined criterion, such as a predetermined number of iterations, is satisfied.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates a framework of an example speech recognition system.

FIG. 2 illustrates an example environment including the example speech recognition system.

FIG. 3 illustrates the example speech recognition system of FIG. 1 in more detail.

FIG. 4 illustrates an example method of training a set of models and feature transforms for speech recognition.

FIG. 5 illustrates an example method of recognizing a speech segment.

### DETAILED DESCRIPTION

### Overview

As noted above, existing speech recognition systems often produce inaccurate recognition results when an incoming utterance or speech segment is obtained from a speaker and/or an environment that is different from speakers and/or environments used in training the speech recognition systems.

This disclosure describes a speech recognition system, which trains a set of acoustic models and feature transforms based on an irrelevant variability normalization (IVN) based discriminative training (DT) approach, and recognizes an unknown speech segment or utterance using the trained acoustic models and feature transforms.

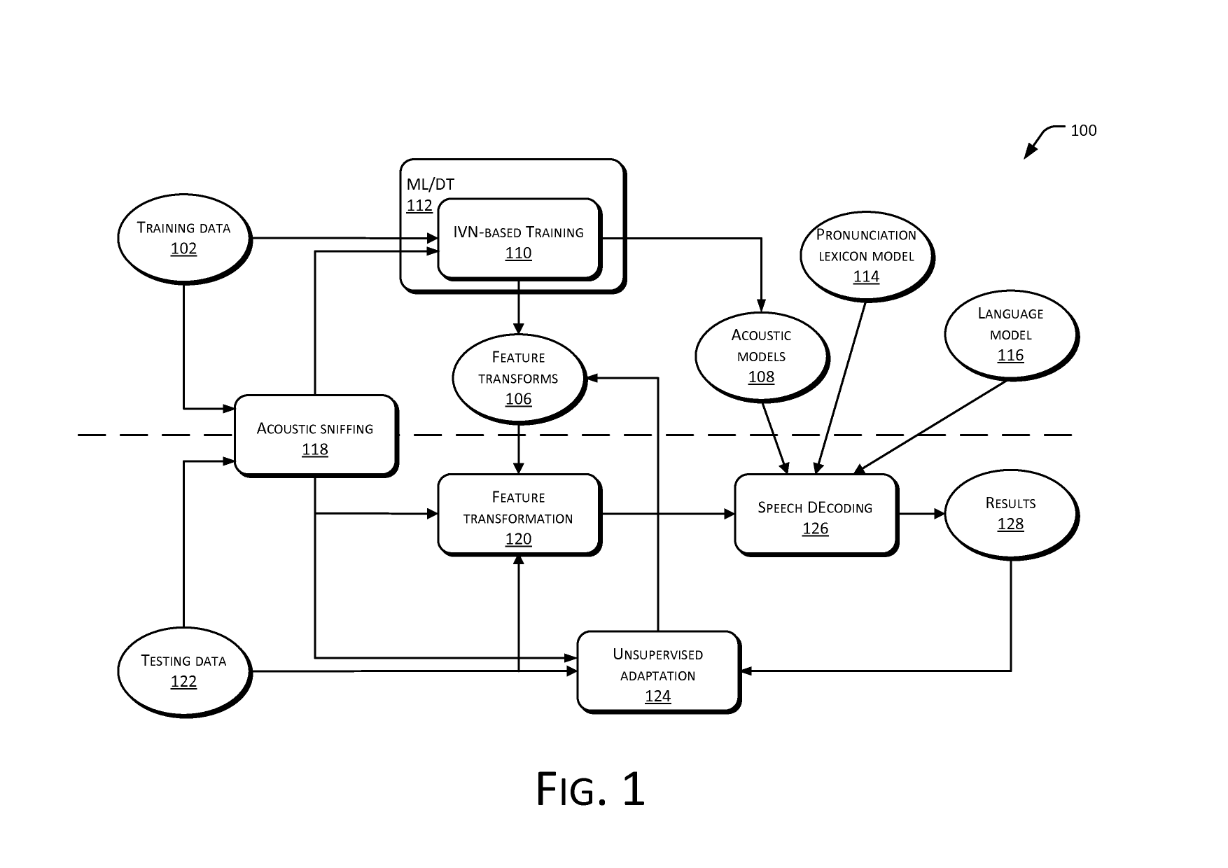

FIG. 1 illustrates an example framework 100 of the speech recognition system. Generally, the speech recognition system receives training data 102 from one or more sources and/or databases 104. The training data 102 may include, for example, speech data of a plurality of speakers recorded in a plurality of different environments. The plurality of speakers may include male and female speakers of different ages. The plurality of different environments and/or conditions may include, for example, a quiet environment, a noisy environment, environments with varying background noises, recordings with varying audio capture devices (e.g., microphones, handsets, etc.), and the like. In one embodiment, the training data may include a large amount of vocabulary usable for training a model for Large Vocabulary Continuous Speech Recognition (LVCSR).

Upon receiving the training data 102, the speech recognition system may train a plurality of feature transforms 106 and a plurality of acoustic models 108 for speech recognition using the training data. In one embodiment, the plurality of feature transforms 106 are feature transforms that are used to transform each speech feature of the training data 102 into a transformed feature. Additionally, the plurality of feature transforms 106 may further ignore or absorb irrelevant variability in each speech feature of the training data 102 (or an unknown speech segment or utterance during a recognition stage). The irrelevant variability is referred to as a variability that is irrelevant to speech recognition and/or phonetic classification. Examples of this irrelevant variability may include, but are not limited to, variability due to speaker characteristics, background noise in the environment, room acoustics in the environment, and noise due to a microphone or speech of other speakers in the background. The speech recognition system may train the plurality of feature transforms 106 to recognize irrelevant variability in speech data. Additionally or alternatively, the speech recognition system may train the plurality of feature transforms 106 to absorb or eliminate this irrelevant variability upon transforming each incoming speech feature into a transformed feature.

In some embodiments, the plurality of acoustic models 108 may include, but are not limited to, generic Hidden Markov Models (HMMs), segment models, dynamic time warping, neural nets, etc. The plurality of acoustic models 108 are configured to discriminate different phonetic classes for speech recognition. In one embodiment, the speech recognition system may employ an irrelevant variability normalization (IVN) based training 110 to obtain the plurality of feature transforms 106 and the plurality of acoustic models 108. The IVN based training allows the plurality of feature transforms 106 and the plurality of acoustic models 108 to focus on variability in speech data that is relevant to speech recognition and/or phonetic classification while ignoring or absorbing irrelevant variability in the speech data.

In one embodiment, the speech recognition system may further employ a discriminative training approach 112 to the IVN based training 110 to obtain the plurality of feature transforms 106 and the plurality of acoustic models 108. In one embodiment, the speech recognition system may employ the discriminative training approach to optimize correctness of the plurality acoustic models 108 by, for example, formulating an objective function that in some ways penalizes one or more parameters of the plurality acoustic models 108 that are liable to confuse correct and incorrect recognitions. In some embodiments, maximum mutual information (MMI) may be used as a training criterion for the discriminative training. In one embodiment, the MMI training criterion considers the plurality of acoustic models simultaneously during the training stage. By way of example and not limitation, during the training stage, the speech recognition system may update, for example, one or more parameters of an acoustic model that correctly recognize an observation (e.g., a speech segment or utterance) of the training data to enhance respective contributions to the observation on the one hand, and update parameters of other acoustic models (and/or other parameters of the acoustic model) to reduce their contributions to the observation of the training data on the other hand.

Additionally, the speech recognition system may further include a pronunciation lexicon model 114 and a language model 116 for speech recognition. The speech recognition may recognize an unknown speech segment under a subset of the plurality of recognition models 108, the pronunciation lexicon model 114 and/or the language model 116.

In some embodiments, the speech recognition system may perform an acoustic sniffing 118 for each feature of the training data 102 during a training stage and/or each feature of an unknown speech segment during a recognition stage. Specifically, the speech recognition system may employ the acoustic sniffing 118 to select one or more feature transforms 106 suitable or capable of ignoring or absorbing irrelevant variability in an incoming feature of the training data 102 or an unknown speech segment and transforming 120 the incoming feature into a transformed feature. In one embodiment, the speech recognition system may select a suitable feature transform under a maximum likelihood (ML) criterion or maximum mutual information (MMI) criterion. Examples of acoustic sniffing 118 may include, but are not limited to, a moving-window approach and a speaker-cluster selection approach.

In one embodiment, the speech recognition system may further include testing data 122 to test or cross-validate an accuracy of the acoustic models 108. In some embodiments, if an accuracy of speech recognition performed by the speech recognition system on the testing data 122 is less than a predetermined accuracy threshold, the speech recognition system may determine to redo the training of the feature transforms 106 and/or the acoustic models 108.

In some embodiments, during a recognition stage, the speech recognition system may further perform unsupervised adaptation 124 of the feature transforms in recognizing an incoming unknown speech segment or utterance. For example, in one embodiment, the speech recognition system may select a respective feature transform for transforming 120 each feature of an incoming unknown speech segment, and transform and recognize 126 each feature of the incoming unknown speech segment. Upon recognizing the incoming unknown speech segment, the speech recognition system may re-estimate parameters of the feature transforms based at least on the recognition results 128 of the incoming unknown speech segment. The speech recognition system may then select a feature transform from the re-estimated feature transforms for each feature of the incoming unknown speech segment, and repeat the recognition of the speech segment and re-estimation of the parameters of the feature transforms until a predetermined criterion is satisfied. In one embodiment, the predetermined criterion may include, but is not limited to, a predetermined number of iterations, a predetermined threshold difference between two consecutive recognition results of the speech segment, a predetermined threshold rate of change between the two consecutive recognition results of the speech segment, and a predetermined confidence level or score determined by a subset of the plurality of acoustic models used for recognizing the unknown speech segment, etc.

The described system allows training a plurality of feature transforms and a plurality of acoustic models for speech recognition, for example, large vocabulary continuous speech recognition (LVCSR). By employing irrelevant variability normalization (IVN) based discriminative training (DT), acoustic sniffing and unsupervised adaptation of the feature transforms in training and recognition of speech data, the speech recognition system can recognize an unknown speech segment or utterance with a higher accuracy as compared with conventional speech recognition systems.

While in the examples described herein, the speech recognition system receives training data, trains a plurality of feature transforms and a plurality of acoustic models, performs acoustic sniffing for each incoming feature, and performs unsupervised adaptation of the feature transforms, in other embodiments, these functions may be performed by multiple separate systems or services. For example, in one embodiment, a training service may train a plurality of feature transforms and a plurality of acoustic models for speech recognition, while a separate service may perform acoustic sniffing for each incoming feature, and yet another service may perform unsupervised adaptation of the feature transforms.

The application describes multiple and varied implementations and embodiments. The following section describes an example environment that is suitable for practicing various implementations. Next, the application describes example systems, devices, and processes for implementing a speech recognition system.

### Exemplary Environment

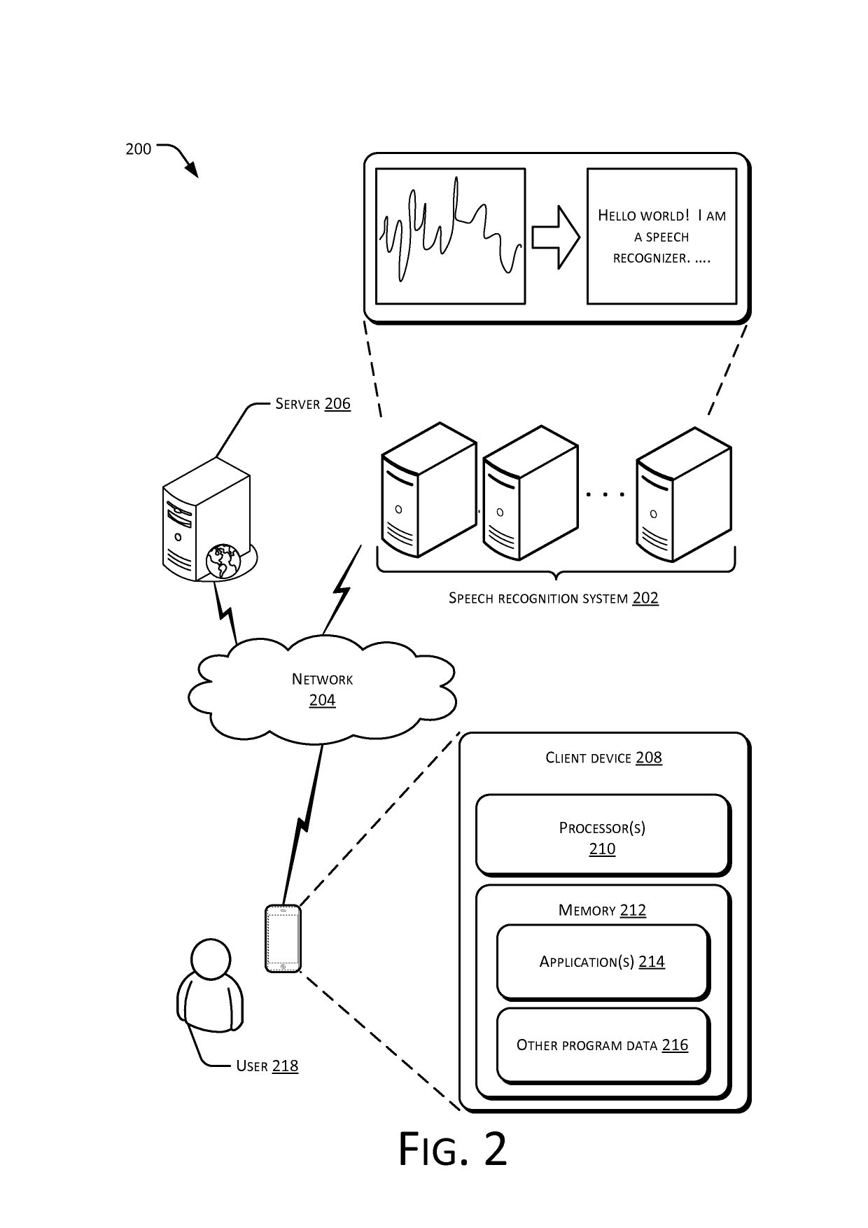

FIG. 2 illustrates an exemplary environment 200 usable to implement a speech recognition system 202. In some embodiments, the environment 200 may include a network 204, a server 206 and/or a client device 208. The server 206 and/or the client device 208 may communicate data with the speech recognition system 202 via the network 204.

Although the speech recognition system 202 is described to be separate from the server 206 and/or the client device 208, in some embodiments, functions of the speech recognition system 202 may be included and distributed among one or more servers 206 and/or one or more client devices 208. For example, the client device 208 may include part of the functions of the speech recognition system 202 while other functions of the speech recognition system 202 may be included in the server 206.

The client device 208 may be implemented as any of a variety of conventional computing devices including, for example, a notebook or portable computer, a handheld device, a netbook, an Internet appliance, a portable reading device, an electronic book reader device, a tablet or slate computer, a game console, a mobile device (e.g., a mobile phone, a personal digital assistant, a smart phone, etc.), a media player, etc. or a combination thereof.

The network 204 may be a wireless or a wired network, or a combination thereof. The network 204 may be a collection of individual networks interconnected with each other and functioning as a single large network (e.g., the Internet or an intranet). Examples of such individual networks include, but are not limited to, telephone networks, cable networks, Local Area Networks (LANs), Wide Area Networks (WANs), and Metropolitan Area Networks (MANs). Further, the individual networks may be wireless or wired networks, or a combination thereof.

In one embodiment, the device 208 includes one or more processors 210 coupled to memory 212. The memory 212 includes one or more applications 214 (e.g., a speech recognition application, a transcription application, etc.) and other program data 216. The memory 212 may be coupled to, associated with, and/or accessible to other devices, such as network servers, routers, the server 206, and/or other client devices (not shown).

A user 218 of the client device 208 may want to transcribe speech captured from the user or another user. For example, the user may employ a transcription application of the client device 208 to transcribe the speech. The transcription application in this example may comprise a front-end application that may obtain the transcription by communicating speech data with the speech recognition system 202.

In response to receiving the speech data from the transcription application, the speech recognition system 202 may recognize the speech using one or more feature transforms and one or more acoustic models included therein and return a recognition result to the transcription application. For example, the speech recognition system 202 may return a transcription result to the transcription application.

In other implementations, in which the client device 208 has sufficient processing capabilities, the speech transcription may be implemented entirely by speech recognition functionality at the client device 208.

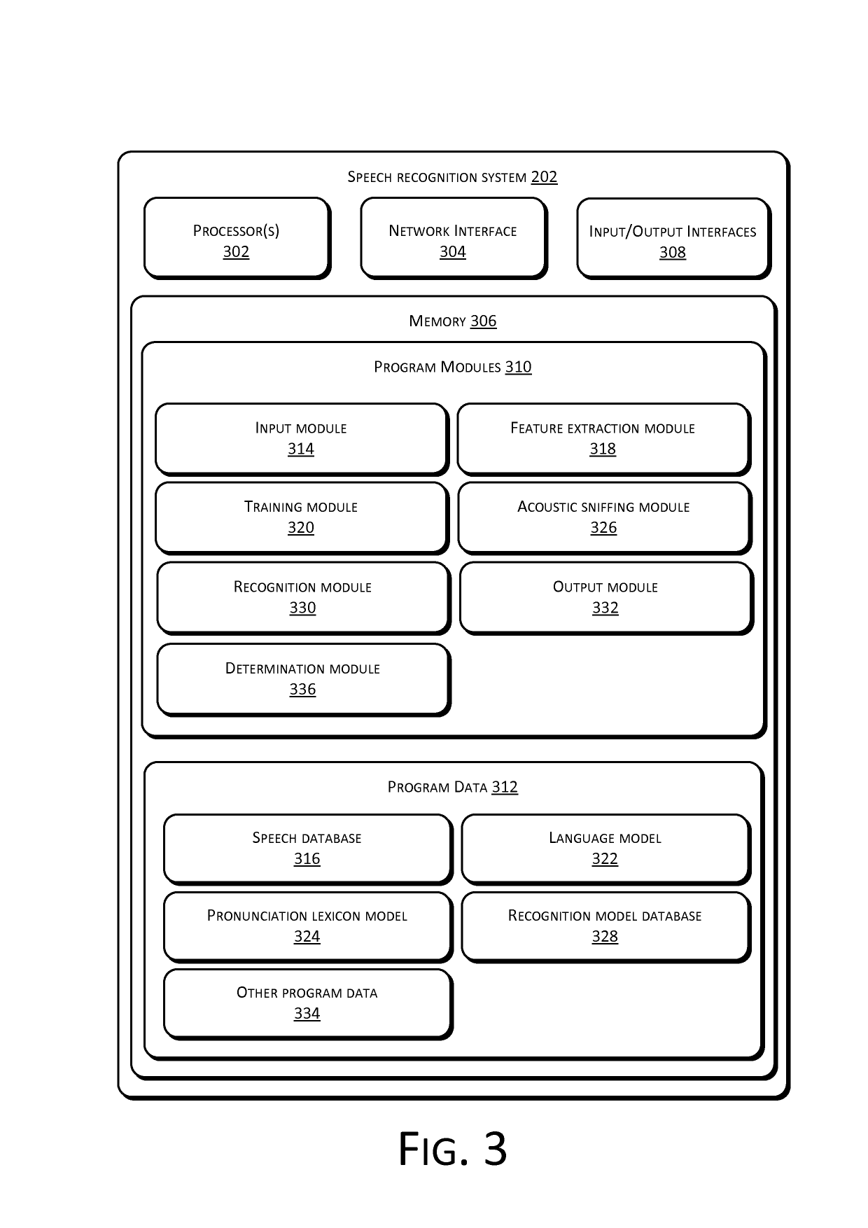

FIG. 3 illustrates the speech recognition system 202 in more detail. In one embodiment, the speech recognition system 202 includes, but is not limited to, one or more processors 302, a network interface 304, memory 306, and an input/output interface 308. The processor(s) 302 is configured to execute instructions received from the network interface 304, received from the input/output interface 308, and/or stored in the memory 306.

The memory 306 may include computer-readable media in the form of volatile memory, such as Random Access Memory (RAM) and/or non-volatile memory, such as read only memory (ROM) or flash RAM. The memory 306 is an example of computer-readable media. Computer-readable media includes at least two types of computer-readable media, namely computer storage media and communications media.

Computer storage media includes volatile and non-volatile, removable and non-removable media implemented in any method or technology for storage of information such as computer readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer readable instructions, data structures, program modules, or other data in a modulated data signal, such as a carrier wave, or other transmission mechanism. As defined herein, computer storage media does not include communication media.

The memory 306 may include program modules 310 and program data 312. In one embodiment, the speech recognition system 302 may include an input module 314. The input module 314 may receive training data from one or more external sources or databases such as the server 206. Additionally or alternatively, the speech recognition system 302 may further include a speech database 316 storing speech data including speech data of a plurality of speakers obtained under a plurality of different environments or conditions. In one embodiment, the training data may include raw speech data or signals that have been recorded. In some embodiments, the training data may include a sequence of speech features or feature vectors of the recorded speech data or signals that have been extracted in advance. The input module 314 may retrieve a subset of the stored speech data as training data from the speech database 316 for training and/or testing a recognition model. In some embodiments, the input module 314 may further receive an unknown speech or utterance from, for example, the client device 208 and perform recognition of the received speech or utterance for the client device 208.

In an event that the training data comprises raw speech data, in some embodiments, the speech recognition system 202 may optionally include a feature extraction module 318 to extract a sequence of features or feature vectors from the training data. The feature extraction module 318 may use one or more conventional feature extraction methods to extract a sequence of features from the training data. Examples of conventional methods may include, but are not limited to, Perceptual linear predictive (PLP) analysis of speech, Gabor wavelets, Mel frequency Cepstral coefficients, Fourier transforms, etc.

In one embodiment, upon extracting the speech features of the training data or retrieving pre-extracted speech features from one or more sources, the speech recognition system 202 may include a training module 320 to train a plurality of feature transforms and a plurality of acoustic models. In one embodiment, the plurality of acoustic models may include, but are not limited to, Hidden Markov Models (HMMs), segment models, dynamic time warping, neural nets, etc. For example, the plurality of acoustic models may include generic HMMs such as Gaussian mixture continuous density HMMs (CDHMMs).

In one embodiment, the plurality of feature transforms may be configured to absorb or ignore variability or information in a speech feature that is irrelevant to phonetic classification. The irrelevant variability or information may include, but is not limited to, variability due to speaker characteristics, background noise in the environment, room acoustics in the environment, noise due to a microphone or speech of other speakers in the background.

In some embodiments, the speech recognition system 202 may further include a language model 322 and a pronunciation lexicon model 324 for each language to be recognized. In one embodiment, the speech recognition system 202 may use any conventional language model and/or pronunciation lexicon model employed in existing speech recognition systems.

In one embodiment, the speech recognition system 202 may further include an acoustic sniffing module 326. The acoustic sniffing module 326 may select or identify a feature transform for each extracted feature of the training data. For example, the speech recognition system 202 may employ a function of a feature transform that is in form of:

xₜ= [symbol] (yₜ;θ)=A^{(e}^{ₜ}⁾yₜ+b^{(l}^{ₜ}⁾ (1)

where yₜ is a t-th D-dimensional feature vector (or feature) of an input feature vector sequence. xₜ is a transformed feature vector. eₜ and lₜ are labels (or transform indices) informed by the acoustic sniffing module 326 for a D×D non-singular transformation matrix A^{(e}^{ₜ}⁾ and D-dimensional bias vector b^{(l}^{ₜ}⁾. θ={A^{(e}^{ₜ}⁾, b^{(l}^{ₜ}⁾|e=1, 2, . . . , E; l=1, 2, . . . , L} denotes a set of feature transformation parameters with E and L being respective total numbers of tied transformation matrices and bias vectors. For ease of description, [symbol] (yₜ; θ) is used to denote a transformed version of a speech segment Y by transforming individual feature vector yₜ of Y as defined in Equation (1).

In one embodiment, the acoustic sniffing module 326 may employ a strategic approach to select or identify a feature transform for a speech feature. By way of example and not limitation, the acoustic sniffing module 326 may employ a moving-window approach to select or identify a feature transform for the speech feature. For example, the training module 320 and/or the acoustic sniffing module 326 may employ the following example moving-window approach during training and recognition stages of the speech recognition system 202.

During a training stage, given feature vector sequences of the training data, for a t-th frame of raw feature vector yₜ, the training module 320 and/or the acoustic sniffing module 326 may calculate a predetermined number (e.g., six) of new D-dimensional feature vectors as follows:

$${\overline{y}}_{t - 3} = \frac{1}{4} ( {y}_{t - 9} + {y}_{t - 8} + {y}_{t - 7} + {y}_{t - 6} ) \\ {\overline{y}}_{t - 2} = \frac{1}{3} ( {y}_{t - 5} + {y}_{t - 4} + {y}_{t - 3} ) \\ {\overline{y}}_{t - 1} = \frac{1}{2} ( {y}_{t - 2} + {y}_{t - 1} ) \\ {\overline{y}}_{t + 1} = \frac{1}{2} ( {y}_{t + 1} + {y}_{t + 2} ) \\ {\overline{y}}_{t + 2} = \frac{1}{3} ( {y}_{t + 3} + {y}_{t + 4} + {y}_{t + 5} ) \\ {\overline{y}}_{t + 3} = \frac{1}{4} ( {y}_{t + 6} + {y}_{t + 7} + {y}_{t + 8} + {y}_{t + 9} ) \qquad ( 2 )$$

The training module 320 and/or the acoustic sniffing module 326 may select this predetermined number (i.e., a window size) and coefficients of Equation (2) arbitrarily. Alternatively, the training module 320 and/or the acoustic sniffing module 326 may select this predetermined number and coefficients of Equation (2) based on information or numbers inputted by an administrator of the speech recognition system 202 or the user of the client device 208, for example. In some embodiments, the training module 320 and/or the acoustic sniffing module 326 may select this predetermined number and coefficients of Equation (2) based on any strategies such as an acoustic context expansion method as described in D. Povey, B. Kingsbury, L. Mangu, G. Saon, H. Soltau, and G. Zweig, “fMPE: Discriminatively Trained Features for Speech Recognition,” Proc. ICASSP-2005, pp. 961-964.

In response to obtaining the predetermined number of new D-dimensional feature vectors, the training module 320 and/or the acoustic sniffing module 326 may combine these predetermined number of new D-dimensional feature vectors with the t-th frame of raw feature vector yₜ. In one embodiment, the training module 320 and/or the acoustic sniffing module 326 may concatenate the predetermined number of new D-dimensional feature vectors with the t-th frame of raw feature vector yₜ. For example, using the above example, the training module 320 and/or the acoustic sniffing module 326 may concatenate y̅ₜ₋₃, y̅ₜ₋₂, y̅ₜ₋₁, yₜ, y̅ₜ₊₁, y̅ₜ₊₂, y̅ₜ₊₃ to form a 7D-dimensional feature vector, zₜ.

Given the new set of training feature vectors {zₜ}, the training module 320 and/or the acoustic sniffing module 326 may train a selection model for identifying a suitable feature transform for transforming a speech feature. In one embodiment, the training module 320 and/or the acoustic sniffing module 326 may train a Gaussian mixture model (GMM) with K components, where each Gaussian component may include a diagonal covariance matrix, for example. In some embodiments, the training module 320 and/or the acoustic sniffing module 326 may further generate two codebooks that are configured to select eₜ and lₜ of Equation (1) for each incoming speech feature.

By way of example and not limitation, the training module 320 and/or the acoustic sniffing module 326 may construct two hierarchical trees using a divisive Gaussian clustering method with E and L leaf nodes respectively. E and L, as described above, respectively represent total numbers of tied transformation matrices and bias vectors for Equation (1). Details of the divisive Gaussian clustering method may be found in, for example, Q. Huo and B. Ma, “Online Adaptive Learning of Continuous-density Hidden Markov Models Based on Multiple-Stream Prior Evolution and Posterior Pooling,” IEEE Trans. On Speech and Audio Processing, vol. 9, no. 4, pp. 388-398, 2001. In one embodiment, the training module 320 and/or the acoustic sniffing module 326 may form two Gaussian codebooks, { [symbol] (z; ξₑ^{(A)}, Rₑ^{(A)})|e=1, 2, . . . , E} and { [symbol] (z; ξₗ^{(b)}, Rₗ^{(b)})|e=1, 2, . . . , L} from the two constructed hierarchical trees.

At both training and recognition stages, given the two codebooks (e.g., the two Gaussian codebooks), for each incoming feature vector yₜ, the training module 320 and/or the acoustic sniffing module 326 may select or identify a feature transform. Continuing with the above example, for each incoming feature vector yₜ, the training module 320 and/or the acoustic sniffing module 326 may select or identify a feature transform (i.e., a transformation matrix and a bias vector) as follows:

eₜ=argmaxₑ [symbol] (zₜ;ξₑ^{(A)},Rₑ^{(A)}) (3)

lₜ=argmaxₗ [symbol] (zₜ;ξₗ^{(b)},Rₗ^{(b)}) (4)

where zₜ is calculated as described above.

In one embodiment, the training module 320 and/or the acoustic sniffing module 326 may apply this approach of acoustic sniffing for a recognition scenario where there is a time or response latency criterion. For example, the user of the client device 208 may want a recognition of speech in real time or close to real time. The speech recognition system 202 may therefore need to start speech recognition after observing or receiving a predetermined number of features or feature vectors or a predetermined time interval, such as 0.1 second, that is small enough to reduce a time lag between a speech to be recognized and a recognition or transcription result of the speech.

Additionally or alternatively, the training module 320 and/or the acoustic sniffing module 326 may employ another approach for the acoustic sniffing. In one embodiment, the training module 320 and/or the acoustic sniffing module 326 may employ a speaker-cluster selection method, e.g., a Gaussian mixture model (GMM) based speaker-cluster selection method for selecting or identifying a suitable feature transform for transforming a speech feature. Details of this GMM-based speaker-cluster selection method can be found in Y. Zhang, J. Xu, Z. J. Yan, and Q. Huo, “A Study of Irrelevant Variability Normalization Based Discriminative Training Approach for LVCSR,” Proc. ICASSP-2011, pp. 5308-5311, which is incorporated by reference herein.

In one embodiment, the training module 320 and/or the acoustic sniffing module 326 may train this speaker-cluster selection approach using the received training data. By way of example and not limitation, a GMM-based speaker-cluster selection approach is described hereinafter for illustration. In one embodiment, the training module 320 and/or the acoustic sniffing module 326 may first initialize the approach and train a predetermined number of Gaussian mixture models using the predetermined number of training sets that are selected from the received training data. For example, the training module 320 and/or the acoustic sniffing module 326 may first train two Gaussian mixture models using respective training data/sets from male and female speakers. The training module 320 and/or the acoustic sniffing module 326 may use each GMM (having M Gaussian components) to represent a speaker cluster.

Given a current set of GMMs, the training module 320 and/or the acoustic sniffing module 326 may classify, for example, each training set (such as each speaker) of the received training data into a speaker cluster, which gives the highest likelihood of respective training set against corresponding GMM of the speaker cluster. In response to obtaining a new speaker clustering result, the training module 320 and/or the acoustic sniffing module 326 may re-estimate GMM for each speaker cluster. In one embodiment, the training module 320 and/or the acoustic sniffing module 326 may repeat these classification and re-estimation for a predetermined number of times, such as ten times.

Additionally or alternatively, the training module 320 and/or the acoustic sniffing module 326 may predefine a maximum number of speaker clusters for this speaker-cluster selection. In an event that the number of speaker clusters has not reached the maximum number of speaker clusters, the training module 320 and/or the acoustic sniffing module 326 may split each speaker cluster into a predetermined number of new clusters by, for example, perturbations of respective mean vector of corresponding GMM. Alternatively, the training module 320 and/or the acoustic sniffing module 326 may split a random set of the speaker clusters. In some embodiments, the training module 320 and/or the acoustic sniffing module 326 may alternatively split a predetermined number of existing speaker clusters that have the first few highest variances among training data in respective speaker clusters.

Upon reaching the maximum number of speaker clusters, the training module 320 and/or the acoustic sniffing module 326 may use these speaker clusters for later identification or selection of a feature transform. For example, in the training stage, the training module 320 and/or the acoustic sniffing module 326 may assign eₜ and lₜ as labels of the speaker clusters. In one embodiment, the training module 320 and/or the acoustic sniffing module 326 may allow all feature vectors in a same speaker cluster to share a same feature transform. Specifically, the total number of feature transforms may be equal to the total number of speaker clusters. In the recognition stage, given an incoming speech data from an unknown speaker, the acoustic sniffing module 326 may perform a speaker classification first. The acoustic sniffing module 326 then selects a pre-trained feature transform from corresponding speaker cluster to transform the incoming speech data (i.e., each feature of the incoming speech data).

In one embodiment, the training module 320 and/or the acoustic sniffing module 326 may selectively employ the moving-window approach and/or the speaker-cluster selection approach based on a time or response latency criterion of the speech recognition. For example, in an event that a real-time or close to real-time recognition is used for the speech recognition, the training module 320 and/or the acoustic sniffing module 326 may employ the moving-window approach for acoustic sniffing. Alternatively, in an event that no real-time or close to real-time recognition is required for the speech recognition, the training module 320 and/or the acoustic sniffing module 326 may employ the moving-window approach and/or the speaker-cluster selection approach to perform the acoustic sniffing.

Although two acoustic sniffing approaches, namely, the moving-window approach and/or the speaker-cluster selection approach, are described above, the training module 320 and/or the acoustic sniffing module 326 may additionally or alternatively employ any other approaches for acoustic sniffing.

Regardless of what acoustic sniffing approach is employed, the training module 320 may (cooperatively or alternately) train the plurality of feature transforms and the plurality of acoustic models using an irrelevant variability normalization based discriminative training approach. In one embodiment, the training module 320 may use generic Hidden Markov Models to model each speech unit for speech recognition. By way of example and not limitation, the training module 320 may employ a Gaussian mixture continuous density HMM (CDHMM) to model each speech unit in the speech recognition system 202. In one embodiment, the training module 320 may model the CDHMM having parameters λ={πₛ, a_{ss′}, cₛₘ, μₛₘ, Σₛₘ; s, s′=1, . . . , S; m=1, . . . , M}. S represents the number of states, and M represents the number of Gaussian components for each state. {πₛ} represents an initial state distribution, and a_{ss′} represents state transition probabilities. cₛₘ represents Gaussian mixture weights while μₛₘ=[μₛₘ₁, . . . , μ_{smD}]^{T} is a D-dimensional mean vector. Σₛₘ=diag{σₛₘ₁², . . . , σ_{smD}²} is a D×D diagonal covariance matrix.

Let Λ={λ} denote the set of CDHMM parameters and [symbol] ={Yᵢ|i=1, 2, . . . , I} is the set of training data, where Yᵢ=(y₁⁽ⁱ⁾, y₂⁽ⁱ⁾, . . . , y_{T}_{ᵢ}⁽ⁱ⁾) is a sequence of D-dimensional feature vectors extracted from an i-th utterance. By using acoustic sniffing, the training module 320 may derive two sets of frame labels for feature transforms (i.e., transformation matrices and bias vectors), [symbol] and [symbol] from [symbol] . In one embodiment, the training module 320 may perform the IVN-based training by adjusting the feature transformation parameters θ and HMM parameters Λ, given a discriminative training criterion. In one embodiment, the training criterion may include a maximum mutual information (MMI) criterion. In some embodiment, the training criterion may include a maximum likelihood (ML) criterion.

Given an MMI criterion, the training module 320 may perform IVN-based discriminative training by maximizing or optimizing an objective function as follows:

$${ℱ}_{MMI} ( Θ , ) = {\sum }_{i = 1}^{I} {ℱ}_{MMI} ( Θ , ; {Y}_{i} , {ℳ}_{i} , ɛ , ℒ ) = {\sum }_{i = 1}^{I} log \frac{p ( {Y}_{i} \vert Θ , ; {ℳ}_{i}^{+} , ɛ , ℒ )}{p ( {Y}_{i} \vert Θ , ; {ℳ}_{i}^{-} , ɛ , ℒ )} \qquad ( 5 )$$

where [symbol] ᵢ⁺ and [symbol] ᵢ⁻ represent a reference model space and a competing model space of Yᵢ respectively. In one embodiment, the training module 320 may use a method of alternating variables to maximize this MMI objective function.

In one embodiment, the training module 320 may alternately estimate one of parameters of the feature transforms and parameters of the acoustic models while fixing the other of the parameters of the feature transforms and parameters of the acoustic models. For example, the training module 320 may estimate the parameters of the feature transforms (e.g., the feature transformation parameters θ) while fixing the parameters of the acoustic models (e.g., the HMM parameters Λ). For example, given the fixed parameters of the acoustic models (e.g., the fixed HMM parameters Λ̅, the training module 320 may optimize or maximize the MMI objective function [symbol] _{MMI}(θ, Λ̅) by increasing an auxiliary function iteratively. In one embodiment, the training module 320 may employ the auxiliary function as follows:

$$\begin{matrix}Q ( Θ , \overline{Θ} ) = 𝒜 ( Θ , \overline{Θ} ) + {𝒜}^{sm} ( Θ , \overline{Θ} ) where & ( 6 ) \\ 𝒜 ( Θ , \overline{Θ} ) = {\sum }_{{s , m , l , e}_{{y}_{t} ∈ {ℒ}_{l} ⋂ {ɛ}_{e}}} ( {γ}_{sm}^{+} ( t ) - {γ}_{sm}^{-} ( t ) ) log {p}_{sm} ( {y}_{t} \vert Θ , \overline{} ) \\ {p}_{sm} ( {y}_{t} \vert Θ , \overline{} ) = 𝒩 ( ℱ ( {y}_{t} ; Θ ) ; {\overline{μ}}_{sm} , {\overline{Σ}}_{sm} ) \vert det ( {A}^{( {e}_{t} )} ) \vert & ( 7 )\end{matrix}$$

[symbol] ₑ and [symbol] ₗ are sets of training feature vectors with an “A matrix” label e and a bias label l respectively. γₛₘ⁺(t) and γₛₘ⁻(t) denote occupancy statistics of Gaussian component m in a state s of an observed feature vector yₜ. Furthermore,

[symbol]

^{sm}(θ, θ̅)=Σ_{s.m.l.e}Dₛₘ^{e,l}∫_{y}pₛₘ(y| θ̅, Λ̅)log pₛₘ(y|θ,Λ)dy (8)

[symbol] ^{sm}(θ, θ̅) is a smoothing function that ensures the [symbol] -function, [symbol] (θ, θ̅), is concave in shape. In one embodiment, the [symbol] -function in Equation (6) is a “weak-sense” auxiliary function for the MMI objective function, which the training module 320 may maximize or optimize by using a method of alternating variables. Specifically, the training module 320 may calculate γₛₘ⁺(t) and γₛₘ⁻(t), and accumulate relevant sufficient statistics. The training module 320 may then increase the [symbol] -function in Equation (6) by the method of alternating variables, which includes alternately estimating one of {A^{(e)}} and {b^{(l)}} while fixing the other of {A^{(e)}} and {b^{(l)}}.

By way of example and not limitation, the training module 320 may estimate {A^{(e)}} while fixing {b^{(l)}}. By differentiating the [symbol] -function with respect to a d-th row of A^{(e)} (hereinafter denoted as A_{d}^{(e)}) and equating it to zero, the training module 320 may derive an updating formula as follows:

$$\begin{matrix}{A}_{d}^{( e )} = {α}_{d}^{( e )} {c}_{d}^{( e )} {F}_{d}^{( e ) - 1} + {j}_{d}^{( e )} {F}_{d}^{( e ) - 1} \\ where {c}_{d}^{( e )} is a cofactor row vector [ {c}_{d 1}^{( e )} … {c}_{dD}^{( e )} ] with {c}_{dj}^{( e )} = cof ( {A}_{dj}^{( e )} ) & ( 9 ) \\ {F}_{d}^{( e ) - 1} = {\sum }_{s , m} \frac{1}{{σ}_{smd}^{2}} [ {G}_{sme} + {\sum }_{l}^{ } {D}_{sm}^{e , l} {C}_{sml} ] \\ {j}_{d}^{( e )} = {\sum }_{s , m} [ {\sum }_{{y}_{t} ∈ {ɛ}_{e}} ( {γ}_{sm}^{+} ( t ) - {y}_{sm}^{-} ( t ) ) \frac{( {μ}_{smd} - {b}_{d}^{( {l}_{t} )} )}{{σ}_{smd}^{2}} {y}_{t}^{⊤} + {\sum }_{l}^{ } {D}_{sm}^{e . l} \frac{( {μ}_{smd} - {b}_{d}^{( l )} ) {( {μ}_{smd} - {b}^{( l )} )}^{⊤}}{{σ}_{smd}^{2}} {A}^{( e ) - 1 ⊤} ] \\ {G}_{sme} = {\sum }_{{y}_{t} ∈ {ɛ}_{e}} ( {γ}_{sm}^{+} ( t ) - {γ}_{sm}^{-} ( t ) ) {y}_{t} {y}_{t}^{⊤} \\ {C}_{sml} = {\overline{A}}^{( e )} [ {\sum }_{sm} + ( {μ}_{sm} - {b}^{( l )} ) {( {μ}_{sm} - {b}^{( l )} )}^{⊤} ] {A}^{( e ) - 1 ⊤} \\ {α}_{d}^{( e )} = \frac{- {ε}_{2}^{( e )} \pm \sqrt{{( {ε}_{2}^{( e )} )}^{2} + 4 {ε}_{1}^{( e )} {β}^{( e )}}}{2 {ε}_{1}^{( e )}} \\ {ε}_{1}^{( e )} = {c}_{d}^{( e )} {F}_{d}^{( e ) - 1 ⊤} {c}_{d}^{( e ) ⊤} \\ {ε}_{2}^{( e )} = {c}_{d}^{( e )} {F}_{d}^{( e ) - 1 ⊤} {j}_{d}^{( e ) ⊤} & \\ {β}^{( e )} = {\sum }_{s , m} {\sum }_{{y}_{t} ∈ {ɛ}_{e}} ( {γ}_{sm}^{+} ( t ) - {γ}_{sm}^{-} ( t ) ) + {\sum }_{s , m} {\sum }_{l} {D}_{sm}^{e , l} & ( 10 )\end{matrix}$$

In one embodiment, the training module 320 may select a value of α_{d}^{(e)} that maximizes

$${Q}_{e} = {β}^{( e )} log \vert {α}_{d}^{( e )} {ε}_{1}^{( e )} + {ε}_{2}^{( e )} \vert - \frac{1}{2} {α}_{d}^{( e ) 2} {ε}_{1}^{( e )} \qquad ( 11 )$$

In one embodiment, [symbol] (θ, θ̅) is concave when β^{(e)}( )>0 and F_{d}^{(e)} is positive definite. Additionally or alternatively, in some embodiments, the training module 320 may include a constraint for Dₛₘ^{e,l} to ensure that the [symbol] -function is concave. By way of example and not limitation, the training module 320 may include a constraint for Dₛₘ^{e,l} as follows:

$${D}_{sm}^{e , l} = EConst * max \{ {D}_{min}^{e} , {\sum }_{{y}_{t} ∈ {ℒ}_{l} ⋂ {ɛ}_{e}} \vert {γ}_{sm}^{+} ( t ) - {γ}_{sm}^{-} ( t ) \vert + \frac{1}{β} \} \\ where Econst > 1 \\ \frac{1}{β} > 0 \\ {D}_{min}^{e} = {max}_{i} \vert \frac{{G}_{sme}^{( ii )}}{{[ {\sum }_{i} {c}_{sml} ]}^{( ii )}} \vert \qquad ( 12 )$$

Gₛₘₑ⁽ⁱⁱ⁾ and [ΣₗCₛₘₗ]⁽ⁱⁱ⁾ are i-th leading principal minors of Gₛₘₑ and ΣₗCₛₘₗ respectively. In one embodiment, the training module 320 may set the values of EConst (e.g., two) and β (e.g., 0.2) automatically or manually upon an input of the administrator of the speech recognition system 202. The training module 320 may update A^{(e)} using the above row-by-row updating formula (i.e., Equation (9)). In one embodiment, the training module 320 may perform this update of A^{(e)} for a predetermined number of iterations Nₐ.

Additionally, the training module 320 may estimate {b^{(l)}} while fixing {A^{(e)}}. In one embodiment, by differentiating the [symbol] -function with respect to b^{(l)} and equating a result thereof to zero, the training module 320 may update each b^{(l)} as follows:

$${b}_{d}^{( l )} = \frac{[ {\sum }_{{{y}_{t} ∈ {ℒ}_{l}}_{s , m}} \frac{{γ}_{sm}^{+} ( t ) - {γ}_{sm}^{-} ( t )}{{σ}_{smd}^{2}} ( {μ}_{smd} - {A}_{d}^{( {e}_{t} )} {y}_{t} ) + {\sum }_{s , m , e} \frac{{D}_{sm}^{e , l}}{{σ}_{smd}^{2}} {\overline{b}}_{d}^{( l )} ]}{{\sum }_{s , m} \frac{{\sum }_{e} {D}_{sm}^{e , l} + {\sum }_{{y}_{t} ∈ {ℒ}_{l}} ( {γ}_{sm}^{+} ( t ) - {γ}_{sm}^{-} ( t ) )}{{σ}_{smd}}} \qquad ( 13 )$$

where b_{d}^{(l)} is a d-th element of a bias vector b^{(l)}, and A_{d}^{(e}^{ₜ}⁾ is a d-th row of the updated matrix A^{(e}^{ₜ}⁾ obtained in the estimation of {A^{(e)}} above.

In one embodiment, the training module 320 may alternately repeat the estimations of {A^{(e)}} and {b^{(l)}} for a predetermined number of times, N_{ab} and update the parameters of the feature transforms, θ. Furthermore, the training module 320 may repeat estimation of the parameters of the feature transforms, θ, for a predetermined number of times, N_{T}.

Additionally, upon updating the parameters of the feature transforms, the training module 320 may update the parameters of the acoustic models (e.g., the HMM parameters, Λ) while fixing the parameters of the feature transforms, θ. In one embodiment, given the updated parameters of the feature transforms (e.g., θ̅) as obtained above, the training module 320 may first transform each training feature vector of the received training data by using the feature transforms (e.g., the feature transformation [symbol] (yₜ; θ̅)). The training module 320 may then train the acoustic models to estimate the parameters of the acoustic models. In one embodiment, the training module 320 may employ any conventional algorithm to train the recognition models. By way of example and not limitation, the training module 320 may estimate the parameters of the acoustic models (e.g., the HMM parameters) that maximize or optimize the MMI objective function [symbol] _{MMI}( θ̅, Λ) using an Extended Baum-Welch algorithm. Furthermore, the training module 320 may estimate the parameters of the acoustic models for a predetermined number of times, Nₕ.

In one embodiment, upon obtaining the estimated parameters of the feature transforms and the estimated parameters of the acoustic models, the training module 320 may further alternate or cooperatively re-estimate the parameters of the feature transforms and the parameters of the acoustic models for a predetermined criterion. The predetermined criterion may include, but is not limited to a predetermined number of iterations/times, N_{c}, a predetermined first threshold for a difference or a rate of change between two consecutive estimation results for the parameters of the feature transforms, and/or a predetermined first threshold for a difference or a rate of change between two consecutive estimation results for the parameters of the acoustic models, etc.

Additionally or alternatively, the training module 320 may further test the feature transforms and the recognition model using testing data that is separate from the received training data. The training module 320 may determine a recognition accuracy of the testing data and determine whether a criterion for the recognition accuracy is satisfied, for example, whether the recognition is greater than or equal to a predetermined accuracy threshold. If the recognition accuracy is less than the predetermined accuracy threshold, the training module 320 may repeat estimations of the feature transforms and the recognition models until the criterion for the recognition accuracy is satisfied. In one embodiment, the training module 320 may use the same testing data, partially new testing data, or completely new testing data for subsequent testing of the feature transforms and the recognition models.

Upon estimating the parameters of the feature transforms and the parameters of the acoustic models, the speech recognition system 202 may include a recognition model database 328 to store the parameters of the feature transforms and the parameters of the acoustic models. The speech recognition system 202 may employ the stored recognition models for recognition of an unknown speech or utterance received at a later time.

In one embodiment, the input module 314 may receive an unknown speech or utterance for speech recognition. The input module 314 may receive this unknown speech or utterance from the client device 208 of the user. In one embodiment, the input module 314 may further receive additional information regarding a time or response latency criterion for this unknown speech or utterance. For example, the user may want a real-time or close-to-real-time recognition of a speech currently given by a speaker. For another example, the user may watch a program using the client device 208 and may want to see a transcription displayed in a display of the client device 208 in real time or close to real time. In an alternative example, the user may want to transcribe a recorded speech and is willing to obtain a transcription result after the entire recorded speech is recognized and transcribed.

Depending on the time or response latency criterion, the input module may transmit the unknown speech or utterance (and possibly additional information) to a recognition module 330. The recognition module 330 may recognize the unknown speech or utterance, and perform an unsupervised adaptation of the trained feature transform for the unknown speech or utterance. In one embodiment, the recognition module 330 may forward the unknown speech or utterance (and possibly additional information) to the acoustic sniffing module 326 for acoustic sniffing.

In response to receiving the unknown speech or utterance (and possibly additional information), the acoustic sniffing module 326 may selectively employ an acoustic sniffing approach suitable for the received time or response latency criterion. For example, in an event that the time or response latency criterion is strict, e.g., requiring a real-time or close-to-real-time recognition, the acoustic sniffing module 326 may choose the moving-window approach for acoustic sniffing. In an event that there is no strict time or response latency criterion, the acoustic sniffing module 326 may choose the moving-window approach and/or the speaker-cluster selection approach for acoustic sniffing. In one embodiment, if no additional information regarding a time or response latency criterion is received, the acoustic sniffing module 326 may arbitrarily select an acoustic sniffing approach (e.g., the moving-window approach and/or the speaker-cluster selection approach, etc.) for acoustic sniffing.

In response to selecting a suitable acoustic sniffing approach for acoustic sniffing, the acoustic sniffing module 326 may select or identify a respective feature transform (that has been trained in the foregoing embodiments) for transforming each feature or feature vector of the unknown speech or utterance. In one embodiment, the acoustic sniffing module 326 may then transform each feature or feature vector of the unknown speech or utterance using respective identified feature transforms.

In response to transforming a feature or feature vector of the unknown speech or utterance, the recognition module 330 may perform recognition of the transformed feature or feature vector using the trained acoustic models (e.g., the trained generic HHMs). In one embodiment, the recognition module 330 may further employ the language model 322 and the pronunciation lexicon model 324 for recognition.

In one embodiment, upon recognizing the unknown speech or utterance, the training module 320 of the speech recognition system 202 may re-estimate the parameters of the previously trained feature transforms (or the identified feature transforms only) using the IVN-based training based on an MML criterion or an ML criterion as described in the foregoing embodiments.

In one embodiment, upon re-estimating the parameters of the previously trained feature transforms (or the identified feature transforms only), the acoustic sniffing module 326 may perform acoustic sniffing to identify a respective new feature transform for each feature or feature vector of the unknown speech or utterance and transform each feature or feature vector using respective new feature transforms. Alternatively, the acoustic sniffing module 326 may simply employ the same set of previously identified feature transforms but with re-estimated parameters for transforming the features or feature vectors of the unknown speech or utterance.

In response to re-transforming the features or feature vectors of the unknown speech or utterance, the recognition module 330 may recognize the unknown speech or utterance using the recognition models. In one embodiment, the speech recognition system 202 may repeat the above unsupervised adaptation (i.e., re-estimation of the parameters of the feature transforms, transforming (and possible acoustic sniffing) the features of the unknown speech or utterance, and recognizing the unknown speech or utterance until a pre-specified criterion is satisfied. By way of example and not limitation, the pre-specified criterion may include, for example, a predetermined number of iterations. Additionally or alternatively, the pre-specified criterion may include, for example, a confidence level or score for the recognition or transcription result determined by the one or more recognition models used in the recognition. In some embodiments, the pre-specified criterion may include a predetermined threshold for a difference or a rate of change between two consecutive recognition or transcription results of the speech segment or speech.

Upon completing the recognition of the unknown speech or utterance, the speech recognition system 202 may include an output module 332 to send a recognition or transcription result to the client device 208 for display to the user, for example. In one embodiment, the recognition or transcription result may include, but is not limited to, a textual transcription of the speech segment or speech, and/or an audio representation (or file) of the speech segment or speech in a linguistic language that is the same as or different from the language of the speech segment or speech.

In one embodiment, the speech recognition system 202 may further include other program data 334. The other program data 334 may include information such as recognition results of any incoming unknown speech or utterance. Additionally, the other program data may further include user feedback of the recognition results such as whether respective recognition results are correct. Additionally or alternatively, the other program data may include user corrections of the recognition results if respective recognition results are incorrect or partly incorrect. In one embodiment, the speech recognition system 202 may further include a determination module 336 that computes a recognition accuracy of the speech recognition system 202 (e.g., the trained feature transforms and/or the trained acoustic models) based on the recognition results and the user feedback or user corrections. The determination module 336 may determine and prompt the training module 320 to re-train the trained feature transforms and/or the trained acoustic models if the computed recognition accuracy is less than a predetermined accuracy threshold for speech recognition.

### Exemplary Methods

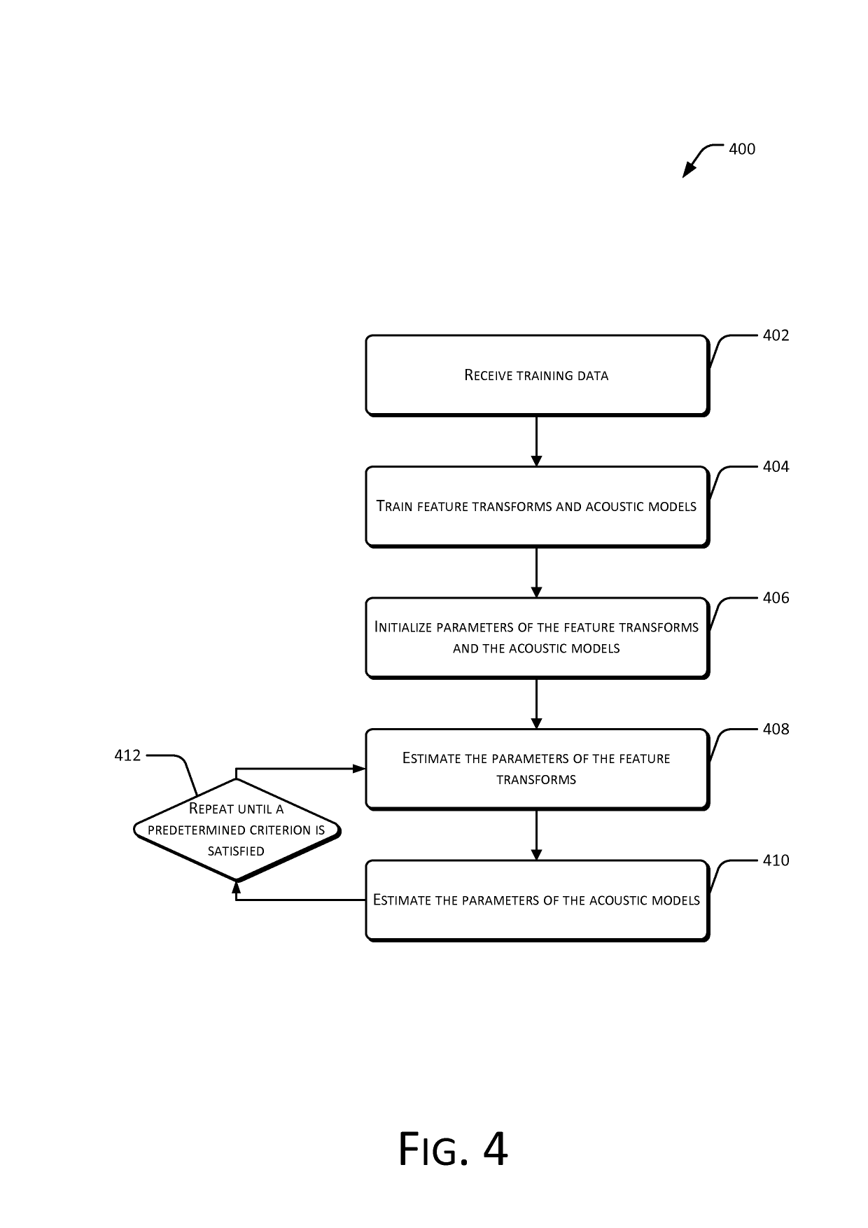

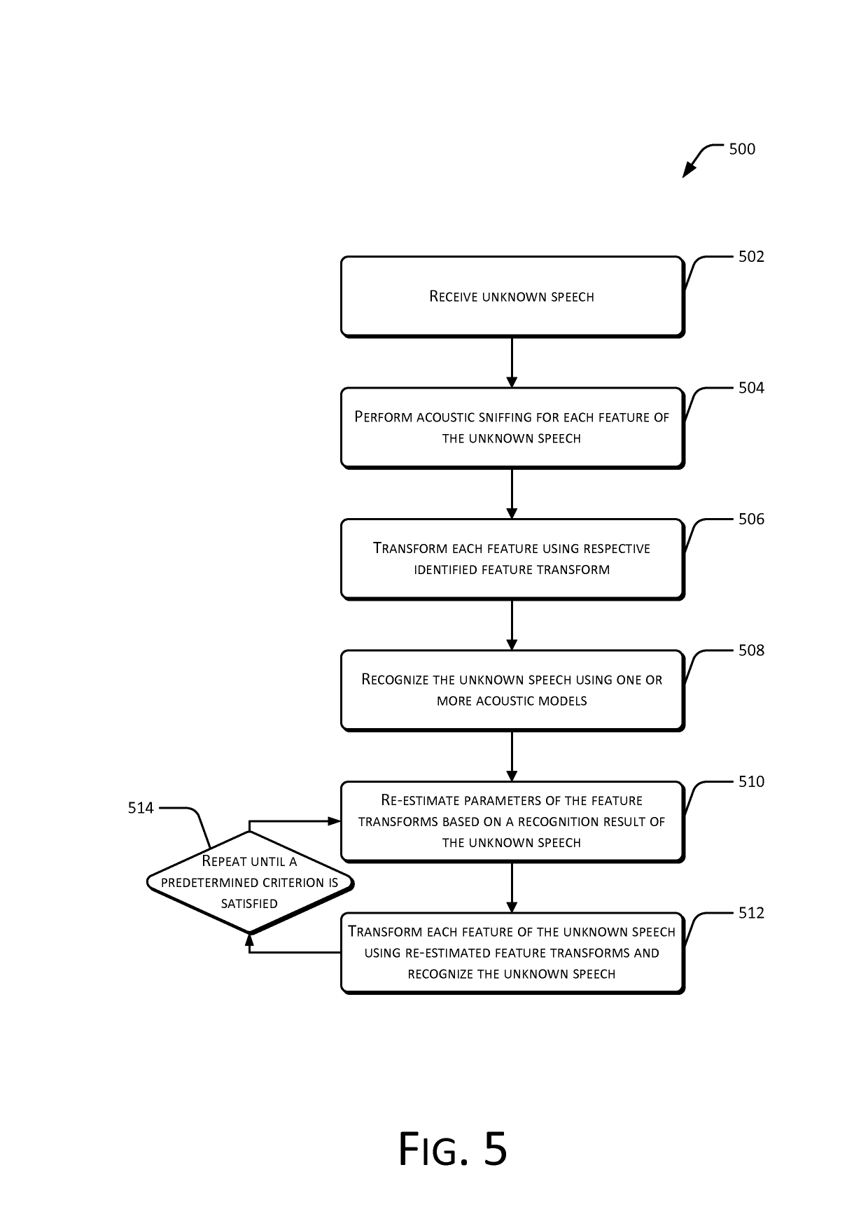

FIG. 4 is a flow chart depicting an example method 400 of training a set of acoustic models and feature transforms for speech recognition. FIG. 5 is a flow chart depicting an example method 500 of recognizing a speech segment or utterance. The methods of FIG. 4 and FIG. 5 may, but need not, be implemented in the environment of FIG. 2 and using the system of FIG. 3. For ease of explanation, methods 400 and 500 are described with reference to FIGS. 2 and 3. However, the methods 400 and 500 may alternatively be implemented in other environments and/or using other systems.

Methods 400 and 500 are described in the general context of computer-executable instructions. Generally, computer-executable instructions can include routines, programs, objects, components, data structures, procedures, modules, functions, and the like that perform particular functions or implement particular abstract data types. The methods can also be practiced in a distributed computing environment where functions are performed by remote processing devices that are linked through a communication network. In a distributed computing environment, computer-executable instructions may be located in local and/or remote computer storage media, including memory storage devices.

The exemplary methods are illustrated as a collection of blocks in a logical flow graph representing a sequence of operations that can be implemented in hardware, software, firmware, or a combination thereof. The order in which the methods are described is not intended to be construed as a limitation, and any number of the described method blocks can be combined in any order to implement the method, or alternate methods. Additionally, individual blocks may be omitted from the method without departing from the spirit and scope of the subject matter described herein. In the context of software, the blocks represent computer instructions that, when executed by one or more processors, perform the recited operations. In the context of hardware, some or all of the blocks may represent application specific integrated circuits (ASICs) or other physical components that perform the recited operations.

Referring back to FIG. 4, at block 402, a speech recognition system, such as speech recognition system 202, may receive training data from one or more sources internally and/or externally. The training data may include, for example, speech data of one or more speakers recorded under one or more different environments. In one embodiment, the speech recognition system 202 may extract features or feature vector sequences from the training data. In some embodiments, the training data received by the speech recognition system 202 may include extracted features or feature vector sequences already.

At block 404, the speech recognition system 202 may train a plurality of feature transforms and a plurality of acoustic models. In one embodiment, the speech recognition system 202 may train the feature transforms and/or the acoustic models using an irrelevant variability normalization (IVN) based maximum likelihood (ML) training. In some embodiments, the speech recognition system 202 may employ a training criterion for training the feature transforms and/or the acoustic models further. In one embodiment, the training criterion may include, but is not limited to a maximum mutual information (MMI) criterion or a minimum classification error (MCE) criterion.

At block 406, the speech recognition system 202 may initiate parameters of the feature transforms and the acoustic models. In one embodiment, the acoustic models may include, for example, generic Hidden Markov Models (HMMs). By way of example and not limitation, the acoustic models may include Gaussian mixture continuous density HMMs (CDHMMs).

At block 408, the speech recognition system 202 may estimate the parameters of the feature transforms. In one embodiment, the speech recognition system 202 may estimate the parameters of the feature transforms while fixing the parameters of the recognition models. In some embodiments, the speech recognition system 202 may develop an objective function for the training criterion. The speech recognition system 202 may estimate the parameters of the feature transforms by optimizing the objective function. In one embodiment, the speech recognition system 202 may divide the parameters of the feature transforms into a plurality of groups and alternately estimate parameters in one group while fixing parameters in remaining groups. In some embodiments, the speech recognition system 202 may repeat alternate estimations of the parameters in each group until a predetermined criterion is satisfied. The predetermined criterion may include, for example, a predetermined number of iterations, a predetermined first threshold for a difference or a rate of change between two consecutive estimation results for the parameters of the feature transforms.

At block 410, the speech recognition system 202 may estimate the parameters of the acoustic models. For example, the speech recognition system 202 may estimate the parameters of the acoustic models while fixing the parameters of the feature transforms. In one embodiment, the speech recognition system 202 may estimate the parameters of the acoustic models by optimizing an objective function, which is based on a criterion including an MMI or MCE criterion. Additionally, the speech recognition system 202 may repeat estimations of the parameters of the acoustic models until a specified criterion is reached. The specific criterion may include, for example, a predetermined number of iterations, a predetermined first threshold for a difference or a rate of change between two consecutive estimation results for the parameters of the acoustic models.

At block 412, the speech recognition system 202 may repeat alternate estimations of the parameters of the feature transforms and the parameters of the acoustic models for a predetermined number of times. Additionally or alternatively, the speech recognition system 202 may repeat alternate estimations of the feature transforms and the parameters of the acoustic models until a second predetermined threshold for a difference or a rate of change between two consecutive estimation results for the parameters of the feature transforms is satisfied. Additionally or alternatively, the speech recognition system 202 may repeat alternate estimations of the feature transforms and the parameters of the acoustic models until a second predetermined threshold for a difference or a rate of change between two consecutive estimation results for the parameters of the acoustic models is satisfied.

Referring back to FIG. 5, at block 502, the speech recognition system 202 may receive an unknown speech. For example, the system may receive the unknown speech from the client device 208. The speech recognition system 202 may segment the unknown speech and extract features or feature vectors from each speech segment.

At block 504, the speech recognition system 202 may perform an acoustic sniffing for each extracted feature of the speech segment. Specifically, the speech recognition system 202 may identify a feature transform that is most suitable for transforming each extracted feature of the speech segment. The speech recognition system 202 may have trained a plurality of feature transforms usable or capable of absorbing or ignoring irrelevant variability in a feature based on, for example, an irrelevant variability normalization (IVN) based discriminative training (DT) as described in the foregoing embodiments. The speech recognition system 202 may use this feature transform to absorb or ignore variability in a feature of the speech segment that is irrelevant to speech classification or recognition.

In one embodiment, the speech recognition system 202 may identify a feature transform for each extracted feature of the speech segment using such a selection approach as the moving-window approach and/or the speaker-cluster selection approach as described in the foregoing embodiments.

At block 506, in response to identifying a feature transform for a feature of the speech segment, the speech recognition system 202 may transform the feature using the identified feature transform.

At block 508, upon transforming a feature of the speech segment, the speech recognition system 202 may perform speech recognition or classification using one or more acoustic models that have been trained using an irrelevant variability normalization (IVN) based discriminative training (DT) as described in the foregoing embodiments.

At block 510, given a recognition or transcription result of the speech segment or the speech, the speech recognition system 202 may re-estimate parameters of the feature transforms based at least on the recognized speech segment or speech. In one embodiment, the speech recognition system 202 may re-estimate the parameters of the feature transforms using the IVN based DT training as described above. Alternatively, the speech recognition system 202 may re-estimate the parameters of the feature transforms using the IVN-based ML training.

At block 512, the speech recognition system 202 may transform each feature of the speech segment using updated parameters of respective identified feature transforms. Alternatively, the speech recognition system 202 may perform a new acoustic sniffing again to identify a new feature transform (with re-estimated parameters) for each feature of the speech segment and transform each feature using respective new feature transforms. Upon transforming a feature, the speech recognition system 202 may perform recognition of the feature using one or more pre-trained acoustic models.

At block 514, the speech recognition system 202 may repeat re-estimation of the parameters of the feature transforms, transformation of the features of the speech segment and recognition of the features for a predetermined number of times. Additionally or alternatively, the speech recognition system 202 may repeat this re-estimation, transformation and recognition until a predetermined criterion is satisfied. By way of example and not limitation, the predetermined criterion may include, for example, a predetermined number of iterations. Additionally or alternatively, the predetermined criterion may include, for example, a confidence level or score for the recognition or transcription result determined by the one or more acoustic models used in the recognition. In some embodiments, the predetermined criterion may include a predetermined threshold for a difference or a rate of change between two consecutive recognition or transcription results of the speech segment or speech. Upon completing the recognition of the speech segment or the speech, the system 202 may send the recognition or transcription result to the client device 208 for display to the user, for example.

Although the above acts are described to be performed by the speech recognition system 202, one or more acts that are performed by the speech recognition system 202 may be performed by the client device 208 or other software or hardware of the client device 208 and/or any other computing device (e.g., the server 206), and vice versa. For example, the client device 208 may include mechanism and/or processing capability to segment a speech and extract features or feature vectors from each speech segment. The client device 208 may then send these extracted features to the speech recognition system 202 for speech recognition.

Furthermore, the client device 208 and the speech recognition system 202 may cooperate to complete an act that is described to be performed by the speech recognition system 202. For example, the client device 208 may continuously send speech data or extracted features of the speech data to the speech recognition system 202 through the network 204. The speech recognition system 202 may iteratively recognize the speech data or the extracted features of the speech data using unsupervised adaptation. The speech recognition system 202 may continuously send a recognition or transcription result of the speech data to the client device 208 to allow the user of the client device 208 to provide feedback about the recognition or transcription result.

Any of the acts of any of the methods described herein may be implemented at least partially by a processor or other electronic device based on instructions stored on one or more computer-readable media. By way of example and not limitation, any of the acts of any of the methods described herein may be implemented under control of one or more processors configured with executable instructions that may be stored on one or more computer-readable media such as one or more computer storage media.

### CONCLUSION

Although the invention has been described in language specific to structural features and/or methodological acts, it is to be understood that the invention is not necessarily limited to the specific features or acts described. Rather, the specific features and acts are disclosed as exemplary forms of implementing the invention.

What is claimed is:

1. A system for large vocabulary continuous speech recognition, the system comprising:
one or more processors;
memory, communicatively coupled to the one or more processors, storing instructions that, when executed by the one or more processors, configure the one or more processors to perform acts comprising:
receiving training data; and
cooperatively training one or more statistical models and one or more feature transforms from the received training data based on an irrelevant variability normalization (IVN) based discriminative training (DT) approach, the one or more statistical models configured to discriminate phonetic classes from one another, and the one or more feature transforms configured to ignore variability that is irrelevant to phonetic classification from each feature vector of the received training data or an unknown speech segment, wherein the cooperatively training comprises:
deriving the one or more feature transforms by applying an acoustic sniffing to the received training data;
employing a maximum mutual information (MMI) as a training criterion for the discriminative training approach;
generating an objective function specified for the MMI training criterion; and
alternately adjusting parameters of the one or more statistical models and parameters of the one or more feature transforms to maximize the generated objective function under the MMI training criterion.

2. A method comprising:
under control of one or more processors configured with executable instructions:
receiving training data; and
cooperatively training one or more statistical models and one or more feature transforms from the received training data based on an irrelevant variability normalization (IVN) based discriminative training (DT) approach.

3. The method as recited in claim 2, wherein the cooperatively training comprises alternating between estimating parameters of the one or more statistical models and estimating parameters of the one or more feature transforms until a predetermined number of iterations or a confidence level is reached.

4. The method as recited in claim 3, wherein the one or more statistical models are configured to discriminate phonetic classes from one another, and the one or more feature transforms are configured to ignore variability that is irrelevant to phonetic classification from the received training data or an unknown speech segment.

5. The method as recited in claim 2, wherein the cooperatively training comprises:
modeling the one or more statistical models as Gaussian mixture continuous density Hidden Markov Models (CDHMMs); and
deriving the one or more feature transforms by applying acoustic sniffing to each feature vector of the received training data.

6. The method as recited in claim 5, wherein applying the acoustic sniffing comprises applying a moving-window based approach and/or a speaker-cluster selection approach to the received training data.

7. The method as recited in claim 5, wherein the cooperatively training further comprises:
employing maximum mutual information (MMI) as a training criterion for the discriminative training approach;
generating an objective function specified for the MMI training criterion; and
adjusting parameters of the CDHMMs and parameters of the feature transforms to maximize the generated objective function under the MMI training criterion.

8. The method as recited in claim 7, wherein the cooperatively training further comprises:
generating an auxiliary function; and
maximizing the generated auxiliary function by estimating the parameters of the feature transforms while fixing the parameters of the CDHMMs.

9. The method as recited in claim 8, wherein the maximizing comprises applying a method of alternating variables to the generated auxiliary function.

10. The method as recited in claim 7, wherein the adjusting comprises estimating the parameters of the CDHMMs while fixing the parameters of the feature transforms.

11. The method as recited in claim 10, wherein the estimating comprises:
transforming each training feature vector of the received training data using a respective feature transform; and
applying a predetermined number of iterations of Extended Baum-Welch (EBW) algorithm to estimate the parameters of the CDHMMs that maximize the generated objective function.

12. The method as recited in claim 2, further comprising:
receiving an unknown speech segment;
recognizing the unknown speech segment using the trained statistical models and the trained feature transforms.

13. The method as recited in claim 12, wherein the recognizing comprises:
for each feature vector of the unknown speech segment, identifying a respective feature transform of the trained feature transforms using the acoustic sniffing;
transforming each feature vector of the unknown speech segment using the respective feature transform; and
recognizing each transformed feature vector using the trained statistical models.

14. The method as recited in claim 13, further comprising in response to recognizing the unknown speech segment, re-estimating the parameters of the trained feature transforms using a recognized transcription of the unknown speech segment based on the irrelevant variability normalization (IVN) based discriminative training (DT) or maximum likelihood (ML) training approach.

15. The method as recited in claim 14, further comprising repeating the identifying and the transforming using the re-estimated parameters of the trained feature transforms, the recognizing and the re-estimating until a predetermined criterion is reached.

16. The method as recited in claim 15, wherein the predetermined criterion comprises a predetermined number of iterations, a predetermined confidence level and/or a predetermined difference between a new result and a previous result of the recognizing.

17. One or more computer-readable media configured with computer-executable instructions that, when executed by one or more processors, configure the one or more processors to perform acts comprising:
receiving an unknown speech segment; and
recognizing the unknown speech segment using a plurality of statistical models and a plurality of feature transforms that have been trained based on an irrelevant variability normalization (IVN) based discriminative training (DT) approach.

18. The one or more computer-readable media as recited in claim 17, the acts further comprising performing an unsupervised adaptation for recognizing the unknown speech segment, the performing comprising:
for each feature vector of the unknown speech segment, identifying a respective feature transform of the plurality of feature transforms using acoustic sniffing;
transforming each feature vector of the unknown speech segment using the respective feature transform;
recognizing each transformed feature vector of the unknown speech segment using the plurality of statistical models; and
in response to recognizing each transformed feature vector of the unknown speech segment, re-estimating parameters of the plurality of feature transforms using a recognized transcription of the unknown speech segment based on the irrelevant variability normalization (IVN) based discriminative training (DT) or maximum likelihood (ML) training approach.

19. The one or more computer-readable media as recited in claim 18, the acts further comprising repeating the identifying, the transforming, the recognizing and the re-estimating until a predetermined criterion is reached.

20. The method as recited in claim 18, wherein the acoustic sniffing comprises a moving-window based approach or a speaker-cluster selection approach, and wherein the acts further comprise selecting one of the moving-window based approach and the speaker-cluster selection approach based on whether recognition of the unknown speech segment is allowed to start only after a complete utterance of the unknown speech segment.
